(19) United States
(12) Patent Application Publication
(10) Pub. No.: US 2009/0071761 A1
(43) Pub. Date: Mar. 19, 2009

(54) Hydraulic Elevator Stabilization Device

(75) Inventor: Rafal Karol Kruczkowski, Apo, AE (US)

Correspondence Address: RAPHAEL KRUCZKOWSKI, CMR 440 BOX 272, APO, AE, 09175, US

(73) Assignee: Rafal Karol Kruczkowski, Apo (US)

(21) Appl. No.: 11/957,439

(22) Filed: Dec. 15, 2007

Related U.S. Application Data
(60) Provisional application No. 60/900,015, filed on Sep. 17, 2007.

(51) Int. Cl. B66B 1/32

(52) U.S. Cl. 187/288

(57) ABSTRACT

The invented device works by attaching a rotor brake to the traction sheave while anchored to a solid object. When the traction sheave is rotating at normal speeds, the hydraulic pump maintains a consistent oil pressure in the storage tank. In the event of a sudden acceleration in either direction, the control box valve overflows the excess pressure and apples it to the rotor brakes, slowing the movement of the car and stabilizing the traction sheave in addition of the cargo and occupants.

### CROSS REFERENCE TO RELATED APPLICATIONS

USPTO U.S. Pat. No. 815,629 Emergency Brake for Elevators
USPTO U.S. Pat. No. 4,531,617 Overspeed Safety Braking Device
USPTO U.S. Pat. No. 4,923,055 Safety Mechanism for Preventing Unintended Motion in Traction Elevators

### DE 20207996 Treibscheibenbremse

### STATEMENT REGARDING FEDERALLY SPONSORED RESEARCH OR DEVELOPMENT

The presented patent is not sponsored or funded by the US or any other government.

### REFERENCE TO SEQUENCE LISTING, A TABLE, OR A COMPUTER PROGRAM LISTING COMPACT DISC APPENDIX

Not Applicable

### BACKGROUND OF THE INVENTION

Modern elevators employ various safety devices that will quickly halt the passenger car in the event of a system malfunction. Current systems that are employed on elevators include brakes that are mounted on the car, and along the cable from above. These systems have been proven to work, but when they engage the cabin comes to a sudden halt that may injure passengers, or damage cargo.

Another common scenario where the presented device can save cargo and prevent injury is after a system malfunction where the safety brakes halt the car. In this scenario, a building technician may not follow the proper procedures and turn off the currently engaged brake system resulting in a rapid acceleration of the car. The result will be a rapid acceleration of the cabin with no safety mechanism to prevent damage or injury.

The presented device works by pumping oil from a pump attached to the rotating traction sheave. A control box monitors the pressure from the pump and gives it to the oil storage tank. When the pressure from the pump exceeds the pre-determined pressure, indicating a rapid acceleration of the passenger cabin for example, the excess pressure is sent to the brakes—slowing the movement of the cable spool.

The control box's setting is set to apply the brakes when the speed is below the currently installed safety devices. Other safety devices that are currently employed on elevators engage and bring the car to a sudden halt.

### BRIEF SUMMARY OF THE INVENTION

Modern elevators employ various safety devices that either brings the car to a sudden halt, or a controlled stop. For example, the “Emergency Brake for Elevators” U.S. Pat. No. 815,629 from Norton P. Otis and variations of it would bring a freefall car to a sudden halt. Obviously the application for this device is proven and should be installed in parallel to the presented invention. The problem with such a device is the sudden jerk reaction when the device engages. This can cause damage and injury. In addition, most existing systems engage only in one direction. U.S. Pat. No. 4,531,617 is very similar in nature to the invented device. It attaches to the traction sheave and monitors the rotation velocity.

The German patent 20207996 is similar to the present patent, but is specifically design to prevent the car from an uncontrolled rise. The presented invention is designed to operate in both directions and with a gearbox that allows the pump to operate in a more affective manor.

### OBJECT AND ADVANTAGES

The presented device acts independent of any monitoring systems and includes its own braking mechanism. It should not be disengaged for any reason, as it only engages when the car accelerates beyond the predetermined speed. Once this speed is reached, further acceleration is limited and a car that before would have been in a sudden free fall, or rapid rise would simply raise or fall gently to the shaft's limit. This device is also easy in operation as it monitors and engages the brakes without the use of electricity, computer or magnets. In addition to ease of use, the system can be easily tested and serviced, as all components are centrally located.

The presented device can be easily mounted to almost all existing traction elevators and integrated with new elevator systems including; ski-lifts, cranes and other systems that utilize a traction spool that will accelerate rapidly in the event of a malfunction.

### SUMMARY OF INVENTION

The device is composed of five core components. The brake system is mounted to the cable spool and anchored to the motor or some other solid object. The rotation of the cable spool rotates a gear box that adjusts the rotations to supply the pump with the proper speeds. The pump feeds the control box with high pressure oil. The control box monitors the incoming pressure and feeds it to the high pressure storage tank. When the pressure exceeds the calibrated pressure inside the control box, the excess is released to the brakes that engage on the rotor.

### BRIEF DESCRIPTION OF THE DRAWINGS

FIG. 1 is the profile of the device.

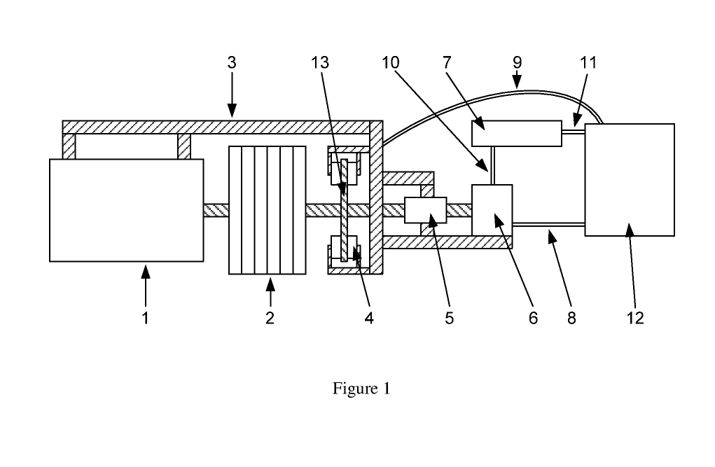

FIG. 2 is the flow process of the device in action.

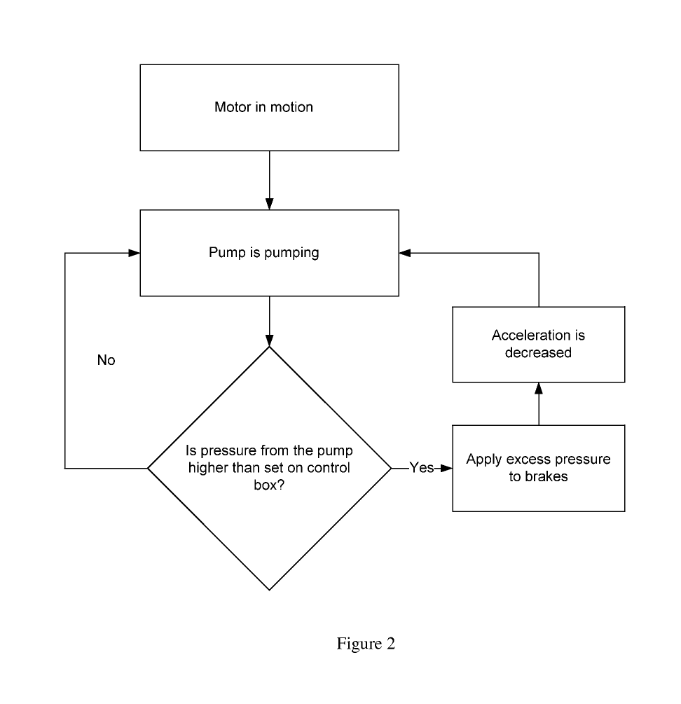

### DESCRIPTION OF THE PREFERRED EMBODIMENT

Unit 1 is the motor, optionally including a transmission that powers the cable spool.
Unit 2 is the cable spool.
Unit 3 is the supporting frame that anchors the brakes and pump.
Unit 4 is the brakes that engage on the rotor.
Unit 5 is the transmission that changes the rotation speed to accommodate the pump.
Unit 6 is the pump that feeds high pressure oil depending on the rotating speed of the cable spool.
Unit 7 is the high-pressure oil storage tank.
Unit 8 is a high-pressure pipe that feeds oil to the control box.
Unit 9 is a high-pressure hose that feeds pressure to the bakes.
Unit 10 is a high pressure pipe that feeds oil to the pump.
Unit 11 is a high pressure oil pipe that feeds oil to the tank.
Unit 12 is the control box that monitors the incoming pressure from the pump.
Unit 13 is the rotor that rotates with the cable spool.

### OPERATION OF INVENTION

There is no need for cables, electricity or computer to operate the device. At the end of the traction sheave, a rotor-based braking system is attached similar to a brake system found in a car. This simple rotor brake system is anchored to the floor or some other solid object. In addition to the brake, the rotating rod is extended from the traction sheave and propels a small gearbox. The gearbox reduces or increases the rotation from the traction sheave depending on the acceleration and elevator type. A larger and faster elevator will require a more sensitive setting than a simpler and slower elevator.

The rotation provided from the gearbox feeds a high pressure pump that operates in both directions. The oil pressure supplied by the pump is variable to the rotation of the traction sheave. Normal operation of the elevator will result in slow rotations from the gearbox, thus low oil pressure from the pump.

The variable oil pressure provided by the pump is fed into the control box where a valve is calibrated to release excess pressure to the rotor brakes in the event of rapid acceleration of the car.

During normal elevator operation, the pump cycles the oil to and from the storage tank, bypassing the valve that goes to the rotor brake.

1. A braking system, comprising:
a hydraulic pump that is fed from the bi-directional rotation of the traction sheave,
the said hydraulic pump rotation is modified by a gearbox that regulates the speed from the traction sheave to pump for optimal operation and sensitivity of the said pump,
oil pressure generated from said pump is feed into a control box,
the said control box monitors incoming oil pressure with a calibrated valve,
and when incoming oil pressure is over the calibrated value, overflow pressure is applied to the rotor brake,
the said brake slows the motion of the traction sheave, stabilizing the movement in both directions.
